(19) United States
(12) Patent Application Publication
(10) Pub. No.: US 2026/0291234 A1
(43) Pub. Date: Sep. 24, 2026

(54) METER-BASED LOAD CONTROL

(71) Applicant: Landis+Gyr Technology, Inc., Alpharetta, GA (US)

(72) Inventors: Matt KARLGAARD, Pequot Lakes, MN (US); Steven John SCHAMBER, Lafayette, IN (US)

(21) Appl. No.: 19/474,271

(22) PCT Filed: Apr. 12, 2024
(86) PCT No.: PCT/US2024/024212

§ 371 Date: Oct. 10, 2025

Related U.S. Application Data
(60) Provisional application No. 63/495,811, filed on Apr. 13, 2023.

(51) Int. Cl. H02J 3/14; H02J 3/38; H02J 13/12; H02J 13/34; H02J 101/24

(52) U.S. Cl. CPC H02J 3/14; H02J 3/38; H02J 13/12; H02J 13/34; H02J 2101/24

(57) ABSTRACT

The present invention relates to systems and methods for meter-based load control via a multi-port meter for controlling loads. The meter comprise a grid port configured for connecting the meter to an electric power grid; one or more auxiliary ports each configured for connecting the meter to a respective distributed energy resource (DER); and a load port configured for connecting the meter to a premises load. A grid switch is connected to the grid port and configured for connecting the grid port to the load port. One or more auxiliary switches are each connected to an auxiliary port and configured for connecting the auxiliary port to the grid port and the load port. The meter or a control unit in communication with the meter comprises a processing unit configured for processing power grid data measured by the meter and controlling states of the grid switch and the one or more auxiliary switches. The system is configured to detect a consumption level through the grid port; compare the detected consumption level to a threshold consumption level; and if the detected consumption level is greater than the threshold consumption level, open at least one of the one or more auxiliary switches.

### TECHNICAL FIELD OF THE DISCLOSURE

The present disclosure relates to a meter-based load control for distributed energy resource compatible multi-port meters.

### BACKGROUND OF THE DISCLOSURE

Electricity meters are used to measure and control consumption at a premises of an end user. More generally, meters may be provided in any resource distribution system, such as an electric grid that delivers electric power, to measure a power consumption of a particular premises. As such, meters may include metrology components for measuring consumption and/or monitoring power characteristics of the premises. Meters may also include communications components, for communicating with other devices on a network.

When a distributed energy resource (DER) device, such as a solar panel, small natural gas-fuelled generator, electric vehicle (EVs), electric vehicle charger, wind generating unit, battery storage system, smart appliance, or another type of controllable load such as a HVAC system or an electric water heater is located at a premises, any power generated or stored by the DER device may also be metered by a multi-port meter and used at the premises or output to an electric grid. Additionally, DER devices such as an EV charger, EV, or energy storage device may receive power from the electric grid for storage and use at a later time. As such, a multi-port meter connected to one or more DER devices may be required to control power flows between several energy sources and several (large) loads. Further complicating this requirement is the fact that the operations of DER devices may be intermittent, requiring varying levels of power inputs and/or providing varying levels of power outputs during different time periods.

In existing designs, separate load-control switches are implemented for load control of specific devices. However, the use of separate (external) switches increases the complexity of the systems, and further increases costs for the end user. There is therefore a need for improved systems for managing and controlling loads in DER compatible systems.

### SUMMARY OF THE DISCLOSURE

In general, aspects of the present disclosure may provide a method and system for providing meter-based load control.

Thus, according to a first aspect of the invention there is provided a multi-port meter for controlling loads, the meter comprising:
a grid port configured for connecting the meter to an electric power grid;
one or more auxiliary or DER ports each configured for connecting the meter to a respective distributed energy resource (DER);
a load port configured for connecting the meter to a premises load;
a grid switch connected to the grid port and configured for connecting the grid port to the load port;
one or more auxiliary switches, each of the one or more auxiliary switches connected to an auxiliary port of the one or more auxiliary ports and configured for connecting the auxiliary port to the grid port and the load port; and
a processing unit configured for processing power grid data measured by the meter and controlling states of the grid switch and the one or more auxiliary switches;
   wherein the meter is configured to:
detect a consumption event; and
open at least one of the one or more auxiliary switches in response to the consumption event.

Advantageously, in a meter according to the present disclosure, if the overall consumption through the grid port exceeds a specified value, one or more auxiliary switches (also referred to as DER switches) can be opened to reduce the risk of or prevent the exceeding of upstream equipment limitations, or a set customer demand limit (to thereby reduce or avoid demand charges).

A consumption event may be any event in which it is desirable for an electric utility customer to change their power consumption in response to the demand for or consumption of power. The consumption event may be a local event (i.e. based on a local detection of consumption by or through the meter) or a global event (i.e. based on a peak time or off peak time for power usage, or any other demand response event). For example, at when the customer's consumption level exceeds a threshold value (i.e. based on a local detection of consumption through the meter), it may be desirable for to reduce their personal consumption of power, to reduce the overall demand on the power supply. Detecting the consumption event may therefore comprise:
detecting a consumption level; and
determining that there is a consumption event if the detected consumption level is greater than a threshold consumption level.

In implementations, the multi-port meter is an N-port meter comprising a plurality of auxiliary ports and a plurality of auxiliary switches. In such cases, when the consumption event is detected, the meter may be configured to open all of the auxiliary switches. The switches may be opened simultaneously, or may be opened in an order based on the preferences of the premises/home owner. For example, devices deemed to be higher priority to the premises may remain in an on state (i.e. with a closed switch) for longer. Alternately, only some but not all of the switches may be opened.

In some examples, the meter may comprise progressively greater first, second, third threshold consumption levels, and respond to the consumption level exceeding each threshold level by progressively opening more of the switches each time a threshold level is exceeded, until all switches are opened in response to a maximum or final threshold consumption level being exceeded.

In some implementations, the meter is configured to prevent all of the auxiliary switches from being closed simultaneously. Advantageously, this may prevent the premises load from being overloaded by the power supply from the electric power grid and multiple DER sources.

In other implementations, the meter may be configured to close all of the auxiliary switches only if the output of one or more DERs through their respective auxiliary ports exceeds a threshold value. For example, the plurality of auxiliary switches may comprise a first auxiliary switch and a second auxiliary switch associated with first and second auxiliary ports respectively. The meter may be configured such that if the first auxiliary switch is closed, the meter may close the second auxiliary switch only if a power flow through the first auxiliary port exceeds a second threshold value. In one implementation, the first auxiliary port is operatively connected to a first DER device, the first DER device being a solar inverter.

The consumption level through the grid port may be determined by any suitable means. For example, the consumption level may be determined based on one or more of a power transferred through the grid port or a current through the grid port, for example in combination with an assumed or otherwise known voltage at the grid port. Alternatively, the consumption event may be detected via the receipt of an indication (e.g. from a utility provider or the power grid) to implement a demand response program.

In some implementations, the multi-port meter is an American National Standards Institute (ANSI) compatible multi-port meter, also referred to as an ANSI Form 43S multi-port meter.

It will be understood that the meter may be controlled via dedicated hardware or software running on a processing unit or other computing device. The processing unit may be incorporated into the meter, or an external device that is connected to or otherwise in communication with the meter, such as a control unit. The control unit may be an external unit configured to control the switches of the meter, and may comprise one or more communication channels for communicating with the meter.

As such, according to a second aspect of the invention there is provided a system for controlling loads of an electricity meter, the system comprising:
a multi-port meter comprising:
   a grid port configured for connecting the meter to an electric power grid;
   one or more auxiliary or DER ports each configured for connecting the meter to a respective distributed energy resource (DER);
   a load port configured for connecting the meter to a premises load;
   a grid switch connected to the grid port and configured for connecting the grid port to the load port;
   one or more auxiliary switches, each of the one or more auxiliary switches connected to an auxiliary port of the one or more auxiliary ports and configured for connecting the auxiliary port to the grid port and the load port;
one or more processors; and
a non-transitory computer readable medium comprising instructions that, when read by the one or more processors, cause the one or more processors to carry out the following steps:
detect a consumption event through the grid port;
open at least one of the one or more auxiliary switches in response to detecting a consumption event.

In a third aspect of the invention, there is provided a method for controlling loads of an electricity meter, the method comprising:
operatively connecting a grid port of a multi-port meter to an electric power grid;
operatively connecting a load port of the multi-port meter to a premises load;
operatively connecting each of one or more auxiliary ports of the multi-port meter to a respective distributed energy resource (DER);
detecting a consumption event; and
opening at least one of the one or more auxiliary switches connected to the one or more auxiliary ports in response to the consumption event, each of the one or more auxiliary switches configured to connect a respective auxiliary port to the grid port and the load port.

The consumption event may be detected through various means. For example, the consumption event may be detected via the receipt of an indication (e.g. from a utility provider or the power grid) to implement a demand response program. Alternatively, detecting a consumption event may comprise:
detecting a consumption level; and
determining that there is a consumption event if the detected consumption level is greater than a threshold consumption level.

In implementations, the multi-port meter is an N-port meter comprising a plurality of auxiliary ports and a plurality of auxiliary switches, and the method comprises opening all of the auxiliary switches if the detected consumption level is greater than the threshold consumption level.

In other implementations, the multi-port meter is an N-port meter comprising a plurality of auxiliary ports and a plurality of auxiliary switches, and the method comprises preventing all of the auxiliary switches from being closed simultaneously.

The plurality of auxiliary switches may comprise a first auxiliary switch and a second auxiliary switch associated with first and second auxiliary ports respectively. In such examples, the method may comprise:
closing the first auxiliary switch; and
closing the second auxiliary switch only if a power flow through the first auxiliary port exceeds a second threshold value.

The method may comprise determining the consumption level through the grid port based on one or more of a power transferred through the grid port, a current through the grid port, or a voltage at the grid port.

These above examples are not intended to limit or define the limits of the present subject matter, but to provide an example to aid understanding thereof. Illustrative examples are discussed in the Detailed Description below, and further description is provided there. Advantages offered by various examples may be further understood by examining this specification and/or by practicing one or more examples of the claimed subject matter.

### BRIEF DESCRIPTION OF THE EMBODIMENTS

Some embodiments of the disclosure will now be described by way of example only and with reference to the accompanying drawings, in which:

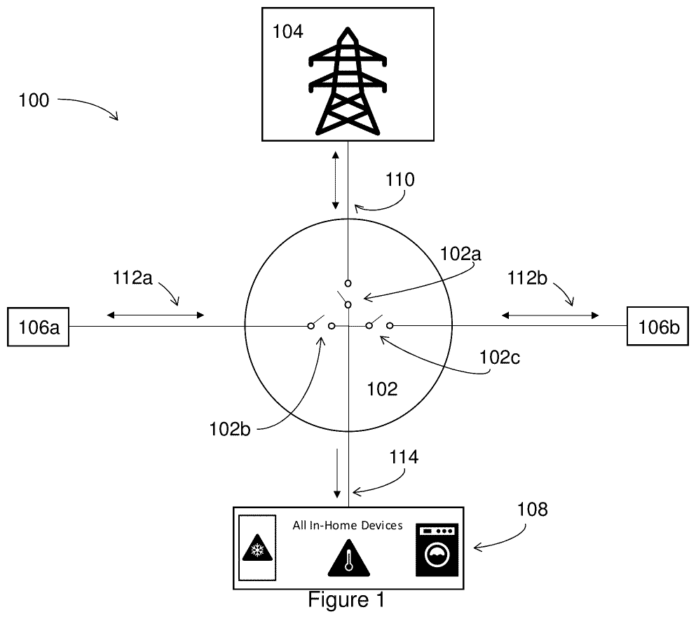

FIG. 1 depicts a schematic diagram of an example system according to the present disclosure.

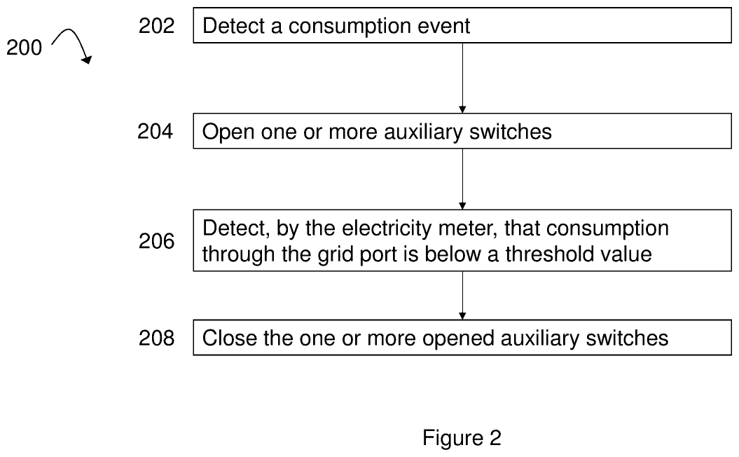

FIG. 2 depicts a flow diagram of an example method according to the present disclosure.

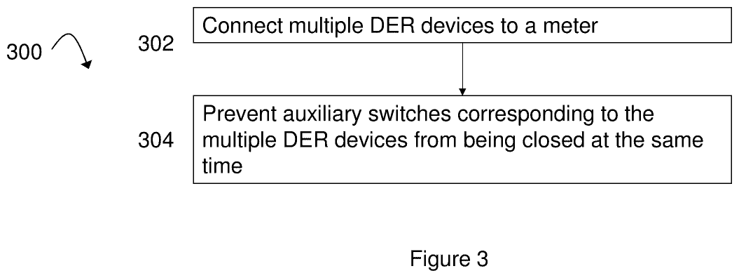

FIG. 3 depicts a flow diagram of a further example method according to the present disclosure.

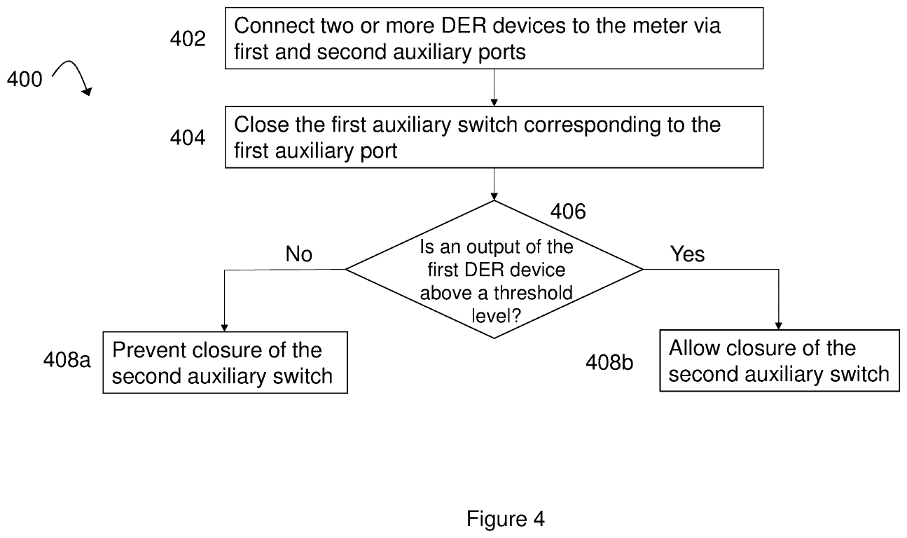

FIG. 4 depicts a flow diagram of a further example method according to the present disclosure.

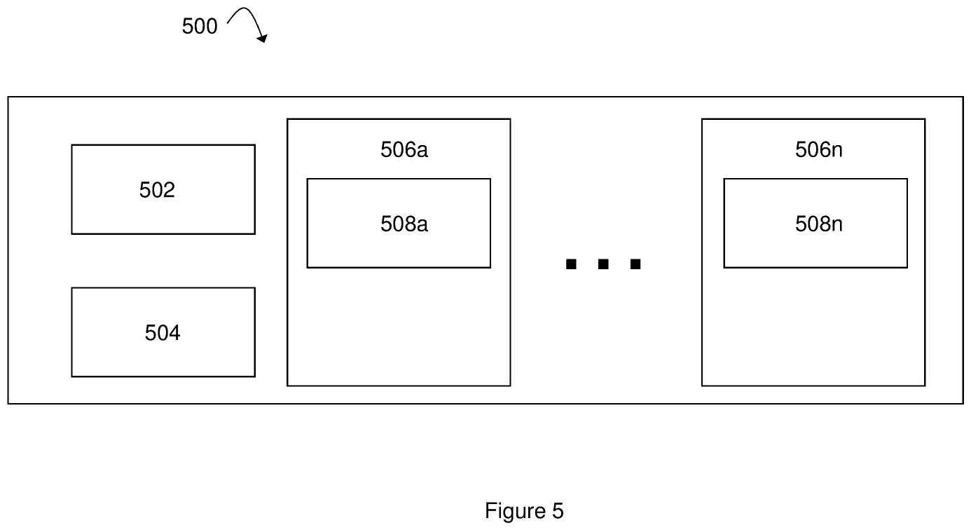

FIG. 5 depicts a schematic block diagram of an example electricity meter according to the present disclosure.

### DETAILED DESCRIPTION OF THE EMBODIMENTS

Aspects of the invention will now be described by reference to example embodiments. It will be understood that the implementations depicted and described herein are provided as illustrative examples, and are not intended to limit the scope of the present invention to only the depicted embodiments.

Broadly speaking, systems and methods according to the present disclosure utilize disconnect switches in a multi-or N-Port meter to directly control large loads, and in particular in US meter forms 43S, 42S, and other possible ANSI meter forms currently being conceptualized. Implementations of the present disclosure may also include automatic behavior of the switches based on certain measured conditions. For example, the methods may be implemented by an algorithm. The algorithm may be implemented by hardware or by software e.g. implemented on a processing unit, for example a processor of the meter or a processor of an external computing device such as a control unit in communication with the meter. The control unit may receive information from the meter, such as the number of connected (DER) devices whether those devices are generating devices or loads, the current power generated by or consumed by those devices, the current consumption through a grid port connected to a grid, etc. and determine whether to open or close switches related to the meter ports, to thereby operatively connect or disconnect the devices from the meter.

Advantageously, the provision of in-meter disconnect switches associated with each of the auxiliary ports provides a meter-based load control solution that is simpler and lower cost than existing systems, which generally utilise separate load control switches. By being an integral part of the meter, the switches further allow for simple implementations of advanced logic control processes, which are limited in separate load control switches by requirements for coordination between the meter and the external switches. Additionally, by implementing meter based control of the distributed energy resource loads, the present disclosure may provide greater visibility of distributed energy resources to utility companies.

FIG. 1 depicts a schematic diagram of a system 100 according to an embodiment of the disclosure. The system comprises a multi-port electricity meter 102 with ports 110, 112a, 112b and 114. Grid port 110 is configured for connecting to the utility grid 104 or other electricity supply, such as a building specific generator. Load port 114 is configured connecting to a load 108, for example a premises such as a home or other building.

Auxiliary ports 112a and b are configured to connect to or be connected to distributed energy resources (DERs). The DERs 106a,b may comprise, but are not limited to, solar panel arrays, wind turbines, water turbines, batteries or other energy storage systems, electric vehicle (EV) chargers, EVs, or generators. As such, auxiliary ports 112a,b may also be referred to as DER ports, and the phrases auxiliary port and DER port are used interchangeably in the present disclosure.

While meter 102 is depicted as an N-port meter with two DER ports 112a,b (and four ports in total), it will be understood that meter 102 may be a multi-port meter (i.e. with a single auxiliary/DER port) or N-port meter with 2 or more DER ports. In other words, port 112b is an optional port, and further optional ports may be provided in addition to port 112b. Each DER port may be connected to a respective DER device such that there is a one-to-one relationship between DER ports and DER devices, such that the meter may control (e.g. enable or disable) each DER device individually. Alternatively, multiple DER devices may be connected to a single DER port, such that the multiple DER devices are controllable by the meter via a single action. This may be advantageous in situations in which the usage of the multiple DER devices are closely correlated, such as for a machine washer and machine dryer, or where multiple of the same DER devices are provided (such as multiple EV chargers in a household with multiple EVs). It will be further understood that the meter 102 may comprise additional auxiliary ports which are not connected or configured for connection to DER devices.

Auxiliary ports 112a,b and grid port 110 may each comprise a respective disconnect switch 102a,b,c, configured to connect the various ports to each other and to the load port 114. This means that, as each DER device 106a,b in system 100 may be individually connected to a unique DER auxiliary port (i.e. 1 total device for a multi-port meter with 1 DER port, 2 devices for the 4-port meter with 2 DER ports, and so on), the DER devices 106a,b may be enrolled in a demand response program and switched on or off using the auxiliary disconnect switches 102b,c for the relevant port in the meter 102, while the main home load port 102 remains powered.

As briefly discussed above, conditional logic may be applied for various use cases of the system 102 in a demand response program. Example use cases are described with reference to FIGS. 2-4 below. It will be understood that these use cases are provided as examples, and other use cases may fall within the scope of the present disclosures.

FIG. 2 depicts a flow chart of an example method 200 for load balancing according to the present disclosure. In step 202, the meter detects a consumption event. For example, the meter may receiving an indication of a consumption event such as a demand response event (e.g. from the utility provider or the power grid), and/or may detect that the overall consumption through the grid port exceeds a specified value.

To detect a consumption level, the meter, for example, may monitor a current or power value through the grid port. For example, the meter may measure a current and voltage across the grid port to determine an overall consumption through the port. Alternatively, rather than measuring a consumption level through the grid port, the meter or controller may receive an indication (e.g. from a utility company) that the total consumption of the power grid is above a threshold level, e.g. as part of a demand response program. In this case, the threshold level may be e.g. a threshold percent of the total capacity of the power network. Instead of receiving an indication, the method may be implemented based on the time of day, e.g. to reduce usage during peak periods. For example, the method may comprise determining that the peak time tariffs are currently being applied.

In step 204, following this detection of a consumption event, one or more auxiliary or DER switches can be opened to prevent the system from exceeding upstream equipment limitations (e.g. as part of the demand response program) or a customer demand limit (e.g. to avoid or reduce demand charges).

Optionally, in steps 206 and 208, the method may further comprise, e.g. at a later time, determining that the condition of step 202 is no longer met, and closing any previously opened switches. For example, the method may comprise determining that consumption through the grid port has fallen below the threshold value, receiving an indication that the consumption across the power network has fallen to a desired level, or determining that a peak usage period has ended, based on e.g. a time of day or the current tariff. It will be understood that the threshold values in steps 202 and 206 may be the same threshold value, or they may be different threshold values. For example, the threshold value in step 206 may be a lower value than the threshold value in step 202, This may reduce the risk of the auxiliary switches being repeatedly opened and closed due to e.g. natural signal noise or other minor fluctuations in the consumption level.

FIG. 3 depicts a second flow chart showing a further example method 300 for load balancing according to the present disclosure. In step 302, multiple (i.e. at least two) DER devices are connected to respective auxiliary (DER) ports of an N-port meter. The meter may comprise programmed or hardwired logic to determine how many of the DER ports are connected to DER devices. In response to the connection of the multiple DER devices, the meter may, in step 304, implement restrictions on the closing of the auxiliary switches corresponding to the DER connected auxiliary ports. For example, as shown in method 300, the meter may prevent all of the relevant (i.e. corresponding to DER connected auxiliary ports) auxiliary switches from being closed at the same time. For example, where the meter comprises two DER ports, each connected to a single DER device, the meter may prevent both of the DER ports from being closed at the same time. By keeping at least some of the DER connected auxiliary switches open at any given time, the meter may again prevent the system from exceeding upstream equipment limitations or a customer demand limit (e.g. to avoid demand charges).

FIG. 4 depicts a third flow chart showing a further example method 400 for load balancing according to the present disclosure. In step 402, multiple (i.e. at least two) DER devices are connected to respective auxiliary (DER) ports of an N-port meter. For example, a first auxiliary port may be connected to a solar inverter, while the second auxiliary port may be connected to a battery or other energy storage means, such as a vehicle-to-everything (V2X) compatible EV charger. More generally, the second auxiliary port may be connected to any load while the first auxiliary port is connected to any energy source for generating power, e.g. for supplying to the power grid. The meter may comprise programmed or hardwired logic to determine how many of the DER ports are connected to DER (or other) devices. In step 404, the meter may close the first auxiliary switch corresponding to the first auxiliary port in response to the connection of the multiple DER devices. In step 406, the meter may compare the input power through the first auxiliary port to a threshold power level. If the meter detects 406 or otherwise determines that the first DER device (such as a solar inverter) is generating power at an output level above the threshold power value, the meter may allow the closure of the second auxiliary switch (e.g. that is connected to a load) (step 408b). Alternatively, if the meter detects that the first DER device is generating power at an output level below the threshold power value, the meter may prevent the second auxiliary switch from closing (step 408a). This method may assist with load balancing in systems in which a DER device or other load connected to the second auxiliary switch consumes or otherwise stores energy, such as if the second DER device is an EV charger, EV, or energy storage device. As a result, by preventing closure of the second auxiliary switch unless the DER device (or other energy source) connected to the first auxiliary switch is producing an output above a specified power value, the meter may simultaneously protect the premises load 108 from reduced power supplies and enable the second DER device to be powered or charged solely through renewable energy sources, such as solar.

While the example method 400 comprises only two DER devices, method 400 may be generalised to any meter connected to two or more DER devices. For example, in a meter comprising any number ‘N’ DER devices connected to ‘N’ auxiliary switches, the meter may detect when an output of energy supplying DER devices connected to closed auxiliary switches is below a threshold value, and prevent any further (currently open) auxiliary switches connected to energy consuming or storing devices from closing.

FIG. 5 depicts a block schematic diagram of an example electricity meter 500. The meter 500 comprises a plurality of ports 506a-n. Optionally, each port 506 of the meter 500 may have an associated switch 508a-n, configured to operatively connect (e.g. when the switch 508 is in a closed state) or operatively disconnect (e.g. when the switch 508 is in an open state) the respective port 506a-n from the other ports of the meter 500. The meter may comprise any number of ports 506, for example 2, 3, 4, 5, 6 or more ports. At least one port is connected or connectable to a DER device.

Electricity meter 500 additionally comprises a storage medium 502 such as a memory and a processor 504. The storage medium 502 may store a computer program or code that, when read by the processor, causes the electricity meter 500 to implement the steps of methods such as methods 200, 300 or 400. Together, the storage medium 502 and processor 504 may form a controller. It will be understood that the controller may be an internal controller forming a component of electricity meter 500, or may be an external controller connected to or in communication with electricity meter 500. Similarly, the functionality of the controller may be implemented in hardware or software, as desired.

It will be understood from the above disclosures that orchestration of the functionality of the above system may be provided at the meter itself or by an external control unit.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. A multi-port meter for controlling loads, the meter comprising:
a grid port configured for connecting the meter to an electric power grid;
one or more auxiliary ports each configured for connecting the meter to a respective distributed energy resource (DER);
a load port configured for connecting the meter to a premises load;
a grid switch connected to the grid port and configured for connecting the grid port to the load port;
one or more auxiliary switches, each of the one or more auxiliary switches connected to an auxiliary port of the one or more auxiliary ports and configured for connecting the auxiliary port to the grid port and the load port; and
a processing unit configured for processing power grid data measured by the meter and controlling states of the grid switch and the one or more auxiliary switches;
wherein the meter is configured to:
detect a consumption event; and
open at least one of the one or more auxiliary switches in response to the consumption event.

2. The meter of claim 1, wherein detecting the demand response comprises:
detecting a consumption level; and
determining that there is a consumption event if the detected consumption level is greater than a threshold consumption level.

3. The meter of claim 1, wherein the multi-port meter is an N-port meter comprising a plurality of auxiliary ports and a plurality of auxiliary switches.

4. The meter of claim 3, the meter is configured to open all of the auxiliary switches in response to the consumption event.

5. The meter of claim 3, wherein the meter is configured to prevent all of the auxiliary switches from being closed simultaneously.

6. The meter of claim 3, wherein the plurality of auxiliary switches comprises a first auxiliary switch and a second auxiliary switch associated with first and second auxiliary ports respectively, wherein when the first auxiliary switch is closed the meter is configured to close the second auxiliary switch only if the first auxiliary port is connected to a generating device and a power flow through the first auxiliary port exceeds a second threshold value.

7. The meter of claim 6, wherein the first auxiliary port is operatively connected to a first DER, and wherein the first DER is a solar inverter.

8. The meter of claim 1, wherein the multi-port meter is an ANSI Form 43S multi-port meter.

9. The meter of claim 2, wherein the consumption level is a consumption level through the grid port, and the meter is configured to:
determine the consumption level based on one or more of a power transferred through the grid port, a current through the grid port, or a voltage at the grid port; and
compare the detected consumption level to a threshold consumption level.

10. The meter of claim 1, wherein detecting the consumption event comprises receiving an indication to implement a demand response program.

11. A method for controlling loads of an electricity meter, the method comprising:
operatively connecting a grid port of a multi-port meter to an electric power grid;
operatively connecting a load port of the multi-port meter to a premises load;
operatively connecting one or more auxiliary ports of the multi-port meter to respective distributed energy resources (DERs);
detecting a consumption event; and
opening at least one of the one or more auxiliary switches connected to the one or more auxiliary ports in response to the consumption event, each of the one or more auxiliary switches configured to connect a respective auxiliary port to the grid port and the load port.

12. The method of claim 11, wherein detecting a consumption event comprises:
detecting a consumption level; and
determining that there is a consumption event if the detected consumption level is greater than a threshold consumption level.

13. The method of claim 11, wherein the multi-port meter is an N-port meter comprising a plurality of auxiliary ports and a plurality of auxiliary switches, and wherein the method comprises opening all of the auxiliary switches in response to the consumption event.

14. The method of claim 11, wherein the multi-port meter is an N-port meter comprising a plurality of auxiliary ports and a plurality of auxiliary switches, and wherein the method comprises preventing all of the auxiliary switches from being closed simultaneously.

15. The method of claim 14, wherein the plurality of auxiliary switches comprises a first auxiliary switch and a second auxiliary switch associated with first and second auxiliary ports respectively, wherein the method comprises:
closing the first auxiliary switch; and
closing the second auxiliary switch only if the first auxiliary port is connected to a generating device and a power flow through the first auxiliary port exceeds a second threshold value.

16. The method of claim 11, wherein the multi-port meter is an ANSI Form 43S multi-port meter.

17. The method of claim 12, wherein the consumption level is a consumption level through the grid port, the method comprising:
determining the consumption level through the grid port based on one or more of a power transferred through the grid port, a current through the grid port, or a voltage at the grid port; and
comparing the detected consumption level to a threshold consumption level.

18. The method of claim 11, wherein detecting a consumption event comprises receiving an indication to implement a demand response procedure.

19. A system for controlling loads of an electricity meter, the system comprising:
a multi-port meter comprising:
a grid port configured for connecting the meter to an electric power grid;
one or more auxiliary ports each configured for connecting the meter to a respective distributed energy resource (DER);
a load port configured for connecting the meter to a premises load;
a grid switch connected to the grid port and configured for connecting the grid port to the load port;
one or more auxiliary switches, each of the one or more auxiliary switches connected to an auxiliary port of the one or more auxiliary ports and configured for connecting the auxiliary port to the grid port and the load port;
one or more processors; and
a non-transitory computer readable medium comprising instructions that, when read by the one or more processors, cause the one or more processors to carry out the following steps:
detect a consumption event through the grid port;
open at least one of the one or more auxiliary switches in response to detecting a consumption event.

20. The system of claim 19, wherein detecting a consumption event comprises:
detecting a consumption level through the grid port;
comparing the detected consumption level to a threshold consumption level; and
determining that there is a consumption event if the detected consumption level is greater than the threshold consumption level,
wherein the consumption level is a consumption level through the grid port, the non-transitory computer readable medium comprising instructions that, when read by the one or more processors, cause the one or more processors to:
determine the consumption level based on one or more of a power transferred through the grid port, a current through the grid port, or a voltage at the grid port; and
compare the detected consumption level to a threshold consumption level; and/or wherein detecting a consumption event comprises receiving a set of instructions that cause the one or more processors to implement a demand response program.

21-23. (canceled)
